(19) United States
(12) Patent Application Publication
(10) Pub. No.: US 2022/0340354 A1
(43) Pub. Date: Oct. 27, 2022

(54) REUSABLE PACKAGING

(71) Applicant: SINOMAX USA INC., Houston, TX (US)

(72) Inventors: Jefre Ramos, Houston, TX (US); Alysabeth Anderson, Houston, TX (US); Courtney Ellis, Houston, TX (US)

(73) Assignee: SINOMAX USA INC., Houston, TX (US)

(21) Appl. No.: 17/668,377

(22) Filed: Feb. 9, 2022

Related U.S. Application Data
(60) Provisional application No. 63/147,675, filed on Feb. 9, 2021.

(51) Int. Cl. B65D 81/36; B65D 5/54; B65D 5/56

(52) U.S. Cl. CPC B65D 81/368; B65D 5/54; B65D 5/563; B65D 2565/384

(57) ABSTRACT

I disclose a packaging article, comprising a wall having an outer surface configured to be visible to consumers and an inner surface configured to secure a product; wherein the wall comprises one or more regions configured to be extracted from the wall, wherein all borders of the region or regions are identified on the inner surface and the region or regions are configured to form a second article or articles other than the packaging article. I also disclose methods of forming the packaging article.

### BACKGROUND OF THE INVENTION

### Field of the Invention

Generally, the present disclosure relates to packaging, and, more specifically, to reusable packaging that provides for forming a second article.

### Description of the Related Art

It is generally desirable, for one or more of manufacturing cost savings, positive associations in the public mind, and regulatory compliance, for providers of consumer goods to promote sustainability. One avenue in which sustainability can be pursued, and which is highly visible to consumers, is on the packaging of such consumer goods. The experience of seeing packaging labeled to specify certain percentages of recycled and/or post-consumer content is common to consumers in North America, Western Europe, and comparable highly developed economies. Another common experience is seeing packaging labeled to encourage consumers to submit the packaging for recycling after use.

That said, the mere encouragement of recycling may be perceived as a relatively meager act of sustainability.

Accordingly, it would be desirable to encourage consumers to perform alternative acts of sustainability relating to packaging articles.

### SUMMARY OF THE INVENTION

The following presents a simplified summary of the disclosure in order to provide a basic understanding of some aspects of the disclosure. This summary is not an exhaustive overview of the disclosure. It is not intended to identify key or critical elements of the disclosure or to delineate the scope of the disclosure. Its sole purpose is to present some concepts in a simplified form as a prelude to the more detailed description that is discussed later.

In one embodiment, the present disclosure is directed to a packaging article, comprising a wall having an outer surface configured to be visible to consumers and an inner surface configured to secure a product; wherein the wall comprises one or more regions configured to be extracted from the wall, wherein all borders of the region or regions are identified on the inner surface and the region or regions are configured to form an article or articles other than the packaging article.

In one embodiment, the present disclosure is directed to a method, comprising forming a packaging article comprising a wall having an outer surface configured to be visible to consumers and an inner surface configured to secure a product; and identifying on the inner surface all borders of one or more regions configured to be extracted from the wall, wherein the region or regions are configured to form an article or articles other than the packaging article.

The present disclosure may provide packaging articles with improved sustainability relative to prior packaging articles.

### BRIEF DESCRIPTION OF THE DRAWINGS

The disclosure may be understood by reference to the following description taken in conjunction with the accompanying drawings, in which like reference numerals identify like elements, and in which:

FIG. 1 presents a stylized perspective view of a packaging article, in accordance with embodiments herein.

FIG. 2 presents a stylized top sectional view of a packaging article, in accordance with embodiments herein.

FIG. 3 presents a stylized top view of an inner surface of a first packaging article, in accordance with embodiments herein.

FIG. 4 presents a stylized top view of an inner surface of a second packaging article, in accordance with embodiments herein.

FIG. 5A presents a stylized top view of an inner surface of a third packaging article, in accordance with embodiments herein.

FIG. 5B presents a stylized isometric view of a packaging article, in accordance with embodiments herein.

FIG. 5C presents a stylized isometric view of a packaging article with a portion cut out, in accordance with embodiments herein.

FIG. 5D presents a stylized isometric top view a cut out portion from the packaging article of FIG. 5C, in accordance with embodiments herein.

FIG. 5E presents a stylized isometric view an article made from the cut out portion of FIG. 5D, in accordance with embodiments herein.

FIG. 6 is a flowchart of a method, in accordance with embodiments herein.

While the subject matter disclosed herein is susceptible to various modifications and alternative forms, specific embodiments thereof have been shown by way of example in the drawings and are herein described in detail. It should be understood, however, that the description herein of specific embodiments is not intended to limit the disclosure to the particular forms disclosed, but on the contrary, the intention is to cover all modifications, equivalents, and alternatives falling within the spirit and scope of the disclosure as defined by the appended claims.

### DETAILED DESCRIPTION

Various illustrative embodiments of the disclosure are described below. In the interest of clarity, not all features of an actual implementation are described in this specification. It will, of course, be appreciated that, in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming but would be a routine undertaking for those of ordinary skill in the art having the benefit of this disclosure.

The present subject matter will now be described with reference to the attached figures. Various structures, systems and devices are conceptually depicted in the drawings for purposes of explanation only and to not obscure the present disclosure with details that are well known to those skilled in the art. Nevertheless, the attached drawings are included to describe and explain illustrative examples of the present disclosure. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

Embodiments herein are directed to packaging articles with improved sustainability relative to prior packaging articles. This improved sustainability may arise by providing consumers with easy and convenient opportunities to transform a region or regions of the packaging article into another useful article or articles.

In one embodiment, the present disclosure relates to a packaging article, comprising a wall having an outer surface configured to be visible to consumers and an inner surface configured to secure a product; wherein the wall comprises one or more regions configured to be extracted from the wall, wherein all borders of the region or regions are identified on the inner surface and the region or regions are configured to form an article or articles other than the packaging article.

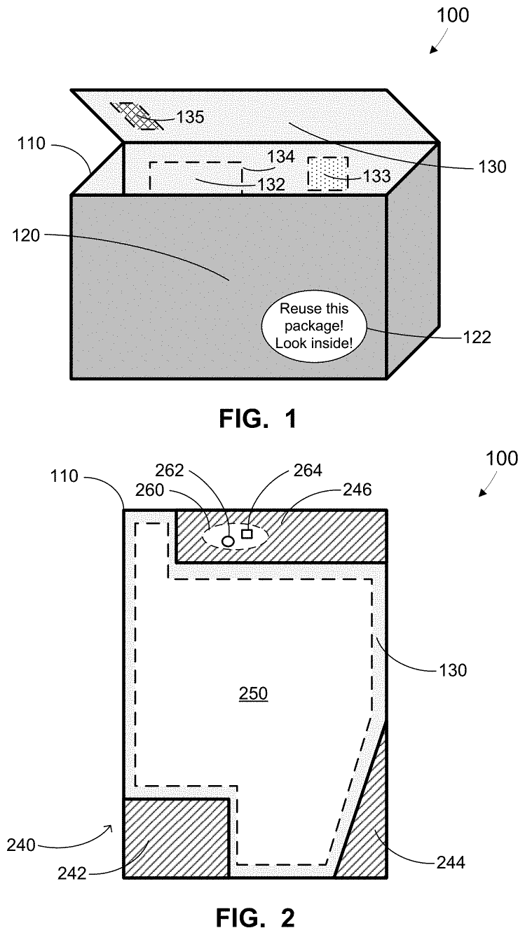

By “packaging article” is meant any article configured for securing a product for transport and/or sale. With reference to FIG. 1, a typical packaging article 100 comprises a wall 110 having an outer surface 120 configured to be visible to consumers and an inner surface 130 configured to secure a product.

The product may be any product for which commerce is desired. In one embodiment, the product may be selected from mattresses, pillows, computers, televisions, audiovisual equipment, appliances, or furniture.

The wall 110 may comprise any suitable material presently known or hereinafter developed. In one embodiment, the wall 110 may comprise paperboard, cardstock, cardboard, corrugated cardboard, plastic, metal, or two or more thereof. In an exemplary embodiment, not shown, the wall 110 may comprise one or more windows covered by a transparent material, such as a transparent plastic, with the remainder of the wall comprising paperboard, cardstock, cardboard, corrugated cardboard, and/or an opaque plastic. Alternatively or in addition, in another exemplary embodiment, also not shown, the wall 110 may comprise one or more windows not covered by any material.

Regardless of the material(s) the wall 110 may comprise, the wall 110 may comprise recycled material. For example, the wall may comprise at least about 5% recycled material; at least about 10% recycled material; at least about 15% recycled material; at least about 20% recycled material; at least about 25% recycled material; at least about 30% recycled material; at least about 35% recycled material; at least about 37.5% recycled material; at least about 40% recycled material; at least about 45% recycled material; at least about 50% recycled material; at least about 55% recycled material; at least about 60% recycled material; at least about 65% recycled material; at least about 70% recycled material; at least about 75% recycled material; at least about 80% recycled material; at least about 85% recycled material; at least about 90% recycled material; or at least about 95% recycled material.

In embodiments, the wall 110 may comprise a biodegradable material.

The wall 110 is not necessarily unitary. The wall 110 may comprise multiple pieces of material joined to one another by one or more of glue, tape, tacks, brads, rivets, screws, staples, cords, threads, strings, laces, paired mating structures (e.g., tabs and slots), etc., as will be apparent to the person of ordinary skill in the art having the benefit of the present disclosure.

The wall 110 comprises one or more regions 132 configured to be extracted from the wall 110. By way of an illustrative example, FIG. 1 shows one region 132. The person of ordinary skill in the art having the benefit of the present disclosure would readily be able to prepare a packaging article 100 comprising two or more regions 132.

The sustainability of the packaging article 100 is enhanced because the region or regions 132 are configured to form an article or articles other than the packaging article 110. As should be apparent, in embodiments, the packaging article 132 may comprise a single region 132 configured to form one article; a single region 132 configured to form one of a plurality of articles; a plurality of regions 132 configured to form one article; or a plurality of regions 132 from which a plurality of articles may be formed.

In the wall 110, all borders 134 of the region or regions 132 are identified on the inner surface 130. The borders 134 may be defined by one or more of printed lines, such as solid, dashed, or dotted lines; perforations; scoring; the mating of two or more pieces of the wall 110; or the like, as will be apparent to the person of ordinary skill in the art having the benefit of the present disclosure. The region or regions 132 is/are configured to be extracted from the wall 110 by one or more actions selected from cutting along a line, separating along a score, tearing a perforation, withdrawal of a tab from a slot, removing a staple, separating two surfaces adhered to one another, untying a cord, cutting a cord, turning a screw, or two or more thereof.

In one embodiment, the wall 110 may comprise at least two zones (not shown). At least one property of the wall 110 may differ between the zones. The property or properties that may differ may be the thickness, density, material, minimum percentage of recycled material, maximum percentage of recycled material, or two or more thereof. In a further embodiment, at least a part of the borders 134 of the region or regions 132 is in a zone comprising less than half of the wall by volume. The zone may have a property rendering the region(s) 132 more readily extractable at the border(s) 134 than if the border(s) 134 were present in a zone having a different property relating to the preponderance of the wall 110.

In one embodiment, a region or regions 133 may be coated on the inner surface 130 of the wall 110 with a waterproof or water-resistant coating. Otherwise, the region or regions 133 may be substantially identical to the region or regions 132 described herein. The coating may extend beyond the borders 134 of the region or regions 133. In this embodiment, the coated region or regions 133 may be configured to form at least part of an external surface of the article(s) other than the packaging article 100. The coated region or regions 133 may render the article(s) more suitable for exposure to weather and/or liquids, e.g., as outdoor article(s), bird feeders, bee feeders, watering bowls for pets and other animals, etc.

In one embodiment, a region or regions 135 may be coated on the inner surface 130 of the wall 110 with an ultraviolet light (UV)-resistant coating. Otherwise, the region or regions 135 may be substantially identical to the region or regions 132 described herein. The coating may extend beyond the borders 134 of the region or regions 135. In this embodiment, the coated region or regions 135 may be configured to form at least part of an external surface of the article(s) other than the packaging article 100. The coated region or regions 135 may render the article(s) more suitable for exposure to sunlight, e.g., as outdoor article(s).

In one embodiment, some or all of the inner and/or outer surfaces 130, 120 of the wall 110 may comprise an antimicrobial and/or antiviral coating, such as those disclosed in U.S. Patent Application 63/035,588, filed Jun. 5, 2020, and hereby incorporated herein by reference. One or more of the regions 133 may comprise the antimicrobial and/or antiviral coating on the inner surface 130 of the wall 110. The antimicrobial and/or antiviral coating may render the packaging article 100 and/or the article(s) that may be formed from the region(s) 133 resistant to microbial and/or viral contamination.

After extraction from the wall 110, the region(s) 132 may be configured to form the article or articles by one or more actions selected from gluing, insertion of a tab into a slot, mating of two slots, stapling, tacking, riveting tying a cord, turning a screw, or two or more thereof.

In embodiments, the packaging article 100 may further comprise one or more other elements. For example, and as depicted in FIG. 1, the packaging article 100 may further comprise one or more elements 122 comprising text or graphics, wherein the element or elements are located on the outer surface 120 and indicate the presence of the region or regions 132 in the wall 110. The element(s) 122 may indicate that the package may be reusable, may indicate which article(s) other than the packaging article 100 may be formed from the region(s) 132, or may otherwise indicate the presence of the region(s) 132. The reusable package may be formed into a planter box, and/or into other articles, including articles described herein.

In embodiments wherein the packaging article 100 further comprises text or graphical elements 122, and/or other printed elements, the inks used in elements 122 or other printed elements may be recycled, recyclable, biodegradable, or two or more thereof.

FIG. 2, which is a stylized top sectional view of a packaging article 100, depicts one embodiment of other elements of the packaging article 100. In this embodiment, the inner surface 130 of the packaging article 100 is configured to secure a product 250 (depicted in outline because the product 250 per se is not a part of the present disclosure) with the cooperation of one or more interior packaging bodies 240, e.g., as depicted, interior packaging bodies 242, 244, and 246. In embodiments, the interior packaging body/ies 240 may comprise paperboard, cardstock, cardboard, corrugated cardboard, plastic, metal, or two or more thereof.

In one embodiment, in addition to cooperating with the inner surface 130 to secure the product 250, the interior packaging body or bodies 240 may be further configured to assist the region(s) in forming the article or articles other than the packaging article.

In still another embodiment, also depicted in FIG. 2, the packaging article 100 may comprise one or more objects, e.g. two objects 262, 264, suitable for use in forming the article or articles. The object(s) 262, 264 may be gathered inside a container 260, such as a plastic bag which may be affixed, e.g. by tape or glue, to an interior or exterior surface of an interior packaging body 240, e.g., as depicted, interior packaging body 246. Other techniques for including the object(s) 262, 264 in the packaging article 100 may be used, as will be apparent to the person of ordinary skill in the art having the benefit of the present disclosure.

In one embodiment, the object or objects (e.g., 262, 264) may be selected from glue, one or more tacks, one or more rivets, one or more staples, one or more cords (by which is meant cords, threads, laces, or strings), one or more screws, or two or more thereof.

The regions 132 may be configured to form any article or articles other than the packaging article 100. In any embodiment, the article or articles other than the packaging article 100 may be selected from pet feeders, pet beds, pet toys, pet houses, jewelry boxes, drawer dividers, tables, chairs, shelving units, mobile phone holders, tablet computer holders, laptop computer holders, media holders, organizers, storage units, toys, clothing and apparel folding aids, planter boxes, or two or more thereof.

In one embodiment, the article or articles other than the packaging article 100 may be selected from dog feeders, cat feeders, bird feeders, small mammal feeders, reptile houses, or two or more thereof.

In one embodiment, the article or articles other than the packaging article 100 may be selected from dog houses, cat houses, bird houses, small mammal houses, reptile houses, or two or more thereof.

In another embodiment, the packaging article 100 may enclose one or more items for use with the article or articles makeable therefrom. For example, if the article(s) include a planter box, the packaging article 100 may enclose, in addition to the packaged consumer good, a packet of seeds, a packet of soil, and/or a packet of fertilizer, for growth of the seeds in the soil in the planter box makeable from the packaging article 100. For another example, if the article(s) include a media disc holder for CDs, DVDs, or the like, the packaging article 100 may enclose a media disc. For yet another example, if the article(s) include an organizer or storage tray for bathroom or bedroom use, the packaging article 100 may enclose an aromatherapy dispenser, a scented oil canister, a candle, incense, or massage oil, among other items encouraging rest or relaxation. The foregoing examples are strictly exemplary and not limiting.

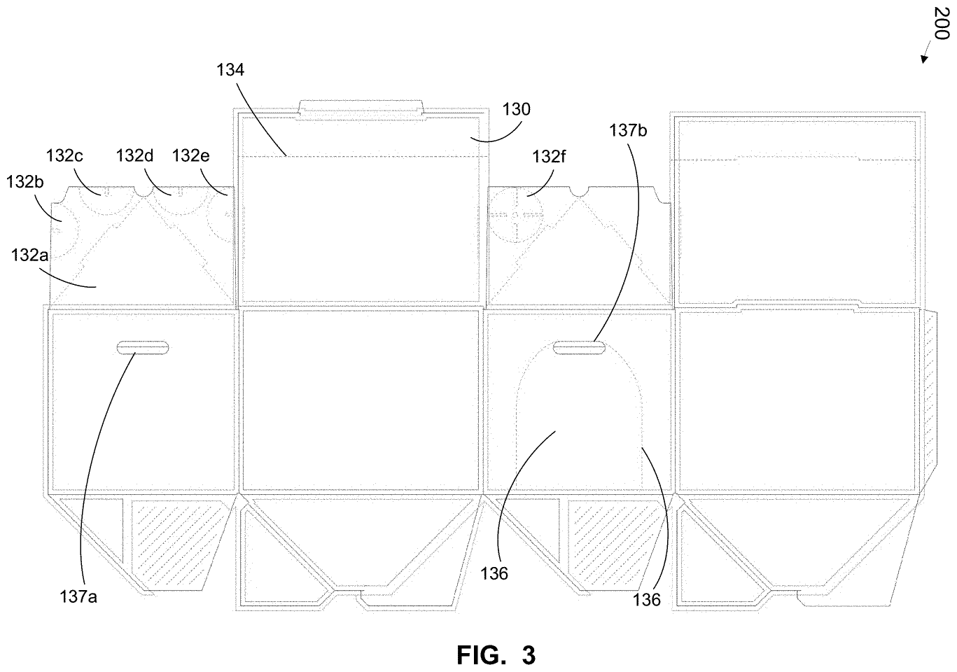

FIG. 3 provides a stylized top view of an inner surface 130 of a packaging article 200, in accordance with embodiments herein. The packaging article 200 has been unfolded, possibly after ungluing, staple removal, flap separation, or the like, and the inner surface 130 has been laid flat. The packaging article 200 of the embodiment depicted in FIG. 3 may comprise cardboard.

The inner surface 130 comprises six regions, 132a-132f. The largest region, 132a, may be extracted from the remainder of the packaging article 200 by separation along borders 134 to yield the main body of a pet play structure. The other regions 132b-132f may be extracted to form adornments for the pet play structure, such as platforms on which a pet may recline, and/or support structures for the pet play structure. A portion 136 may be excised from region 132a to form a door for pet ingress to and egress from the play structure. Also, the packaging article 200 may comprise one or more handles 137 (e.g., handles 137a and 137b) for handling of the packaging article 200 prior to removal of the packaged product. Any handle(s) 137 may be part of any border 134, e.g. handle 137b forms part of the border 134 of portion 136. Any unused portions of the packaging article 200 may be recycled.

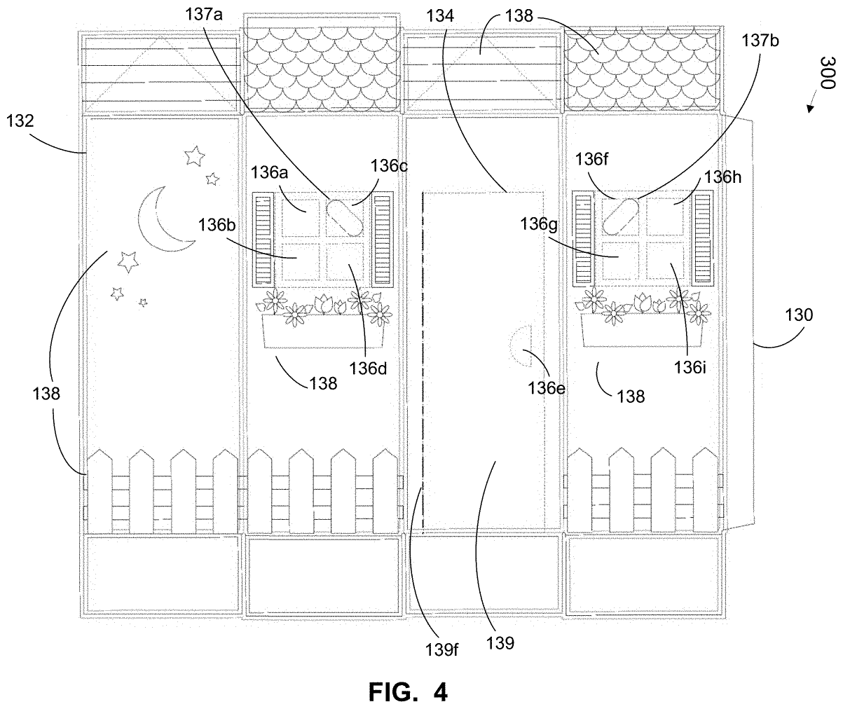

FIG. 4 provides a stylized top view of an inner surface 130 of a packaging article 300, in accordance with embodiments herein. The packaging article 300 has been unfolded, possibly after ungluing, staple removal, flap separation, or the like, and the inner surface 130 has been laid flat. The packaging article 300 of the embodiment depicted in FIG. 4 may comprise cardboard.

The inner surface 130 comprises a primary region 132 which may yield the main body of a child's play structure. The primary region 132 may comprise one or more preprinted graphical elements 138 (e.g., the crescent moon, stars, shutters, flower boxes, picket fence, siding, and shingles depicted in FIG. 4). Portions 136, e.g., 136a-136i may be excised from region 132 to form windows and a door handle. A flap 139 may be cut on top, bottom, and one side, and folded on the other side along line 139f, to yield a door for a child's ingress to and egress from the play structure. Also, the packaging article 300 may comprise one or more handles 137 (e.g., handles 137a and 137b) for handling of the packaging article 300 prior to removal of the packaged product. Any handle(s) 137 may be part of any border 134, e.g. handle 137b forms part of the border 134 of portion 136. Any unused portions of the packaging article 300 may be recycled.

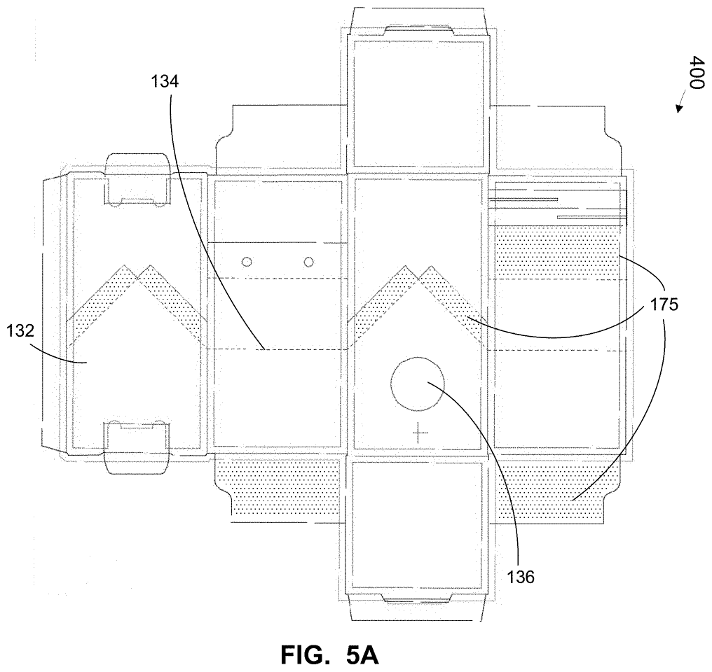

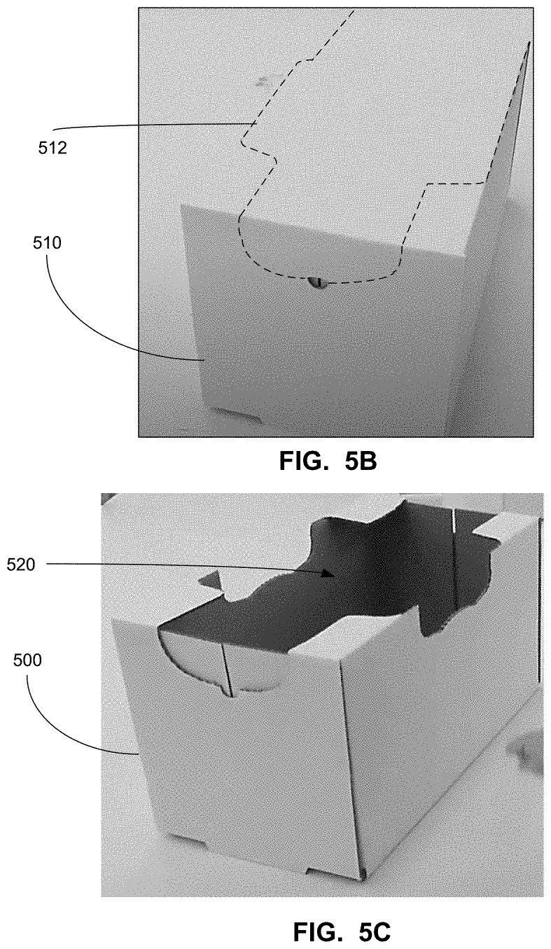

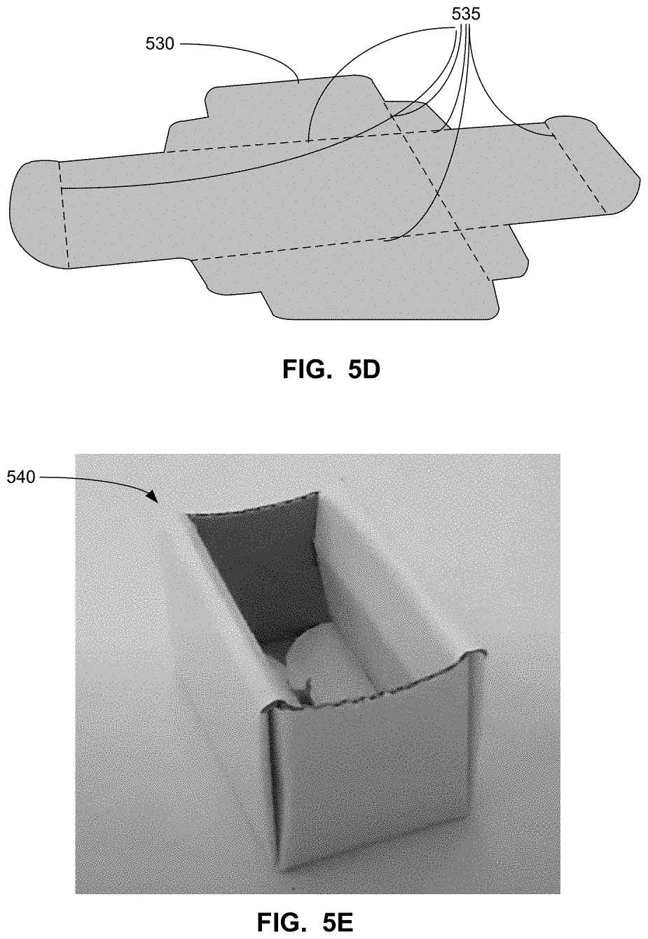

FIG. 5A provides a stylized top view of an inner surface 130 of a packaging article 400, in accordance with embodiments herein. The packaging article 400 has been unfolded, possibly after ungluing, staple removal, flap separation, or the like, and the inner surface 130 has been laid flat. The packaging article 400 of the embodiment depicted in FIG. 5 may comprise cardboard.

The inner surface 130 comprises a primary region 132 which may yield the main body of a birdhouse after extraction along borders 134 and assembly of the birdhouse, e.g., by folding and gluing portions 175. A portion 136 may be excised to yield the door of the birdhouse. Any unused portions of the packaging article 400 may be recycled.

FIG. 5B provides a stylized isometric view of a packaging article 510, in accordance with embodiments herein. The packaging article 510 may comprise one or more perforated features 512, lines, or other features that would allow for removing a portion of the packaging article 510. The perforated features 512 may be formed in a manner that provides for separating a cut out portion based on the perforated features 512 or lines.

FIG. 5C provides a stylized isometric view of the packaging article 510 with a cut out, in accordance with embodiments herein. A cut out portion may be removed from the packaging article 510, as shown in FIG. 5C. Cutting out a portion of the packaging article 510 would result in a void 520 in the packaging article 510.

FIG. 5D provides a stylized view of a cut-out portion, in accordance with embodiments herein. Removing a portion of the packaging article 510 based on the perforated feature 512 may result in a cut-out portion 530. The cut-out portion 530 may comprise multiple fold lines 535. The fold lines 535 may be printed, pressed, or otherwise formed to allow and/or guide folding of the cut-out portion 530 for forming an article, such as planters box.

FIG. 5D provides an stylized isometric view of the recycled article 540, in accordance with embodiments herein. The cut-out portion 530 may be folded and secured in a fashion that a recycled article 540 may be formed. The fold lines 535 may be used as a guide to form the recycled article 540. The recycled article 540 may be a box, such as planters box, or other articles, including articles described herein.

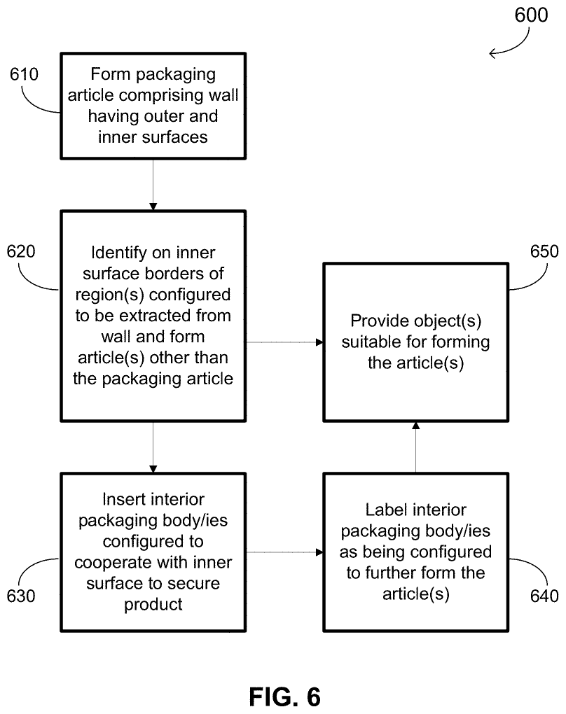

FIG. 6 is a flowchart of a method 600, in accordance with embodiments herein. The method 600 comprises forming (at 610) a packaging article comprising a wall having an outer surface configured to be visible to consumers and an inner surface configured to secure a product. The method 600 also comprises identifying (at 620) on the inner surface all borders of one or more regions configured to be extracted from the wall, wherein the region or regions are configured to form an article or articles other than the packaging article.

In a particular embodiment, identifying (at 620) may comprise perforating, scoring, or both at least a portion of a border of at least one region.

Alternatively, or in addition, in another particular embodiment, identifying (at 620) may comprise specifying a plurality of regions, wherein the regions are configured to form more than one article other than the packaging article.

In addition to the foregoing elements, in one or more further embodiments, the method 600 may comprises one or more additional elements. For example, in one embodiment, the method 600 may further comprise inserting (at 630) into the packaging article one or more interior packaging bodies configured to cooperate with the inner surface to secure the product. In a further embodiment, the method 600 may additionally comprise labeling (at 640) the interior packaging body or bodies as being configured to further form the article or articles other than the packaging article.

Alternatively or in addition, the method 600 may further comprise providing (at 650) one or more objects suitable for use in forming the article or articles, wherein the object or objects are selected from glue, one or more tacks, one or more rivets, one or more staples, one or more cords, one or more screws, or two or more thereof.

101. Embodiments herein may consist a method comprising: forming a packaging article comprising a wall having an outer surface configured to be visible to consumers and an inner surface configured to secure a product; identifying on the inner surface all borders of one or more regions configured to be extracted from the wall, wherein the region or regions are configured to form an article or articles other than the packaging article; and at least one of the following actions: inserting into the packaging article one or more interior packaging bodies configured to cooperate with the inner surface to secure the product, wherein the interior packaging body or bodies are further configured to assist the region or regions in forming the article or articles other than the packaging article; configuring the region or regions to be extracted from the wall by one or more actions selected from untying a cord, cutting a cord, turning a screw, or two or more thereof; providing one or more objects suitable for use in forming the article or articles, wherein the object or objects are selected from glue, one or more tacks, one or more rivets, one or more staples, one or more cords, one or more screws, or two or more thereof providing a plurality of regions, wherein the regions are configured to form more than one article other than the packaging article; forming the packaging article comprises forming the packaging article wall from at least about 37.5% recycled material; forming the wall such that it has at least two zones, wherein at least one property of the wall differs between the zones, and at least a part of the borders of the region or regions is in a zone comprising less than half of the wall by volume; coating at least one of the regions with a waterproof or water-resistant coating, wherein the waterproof or water-resistant coating is on the inner surface of the wall; coating at least one of the regions with an ultraviolet light (UV)-resistant coating, wherein the UV-resistant coating is on the inner surface of the wall; or coating at least a portion of at least one of the inner surface and the outer surface of the wall of the packaging article with an antimicrobial and/or antiviral coating.

102. The method of claim 101, further comprising: inserting into the packaging article one or more interior packaging bodies configured to cooperate with the inner surface to secure the product.

103. The method of claim 102, further comprising: labeling the interior packaging body or bodies as being configured to further form the article or articles other than the packaging article.

104. The method of claim 101, wherein the identifying comprises perforating, scoring, or both at least a portion of a border of at least one region.

105. The method of claim 101, wherein identifying comprises specifying a plurality of regions, wherein the regions are configured to form more than one article other than the packaging article.

106. The method of claim 101, further comprising: providing one or more objects suitable for use in forming the article or articles, wherein the object or objects are selected from glue, one or more tacks, one or more rivets, one or more staples, one or more cords, one or more screws, or two or more thereof.

107. The method of claim 101, further comprising: coating at least one of the regions on the inner surface of the packaging article with a waterproof or water-resistant coating.

108. The method of claim 101, further comprising: coating at least one of the regions on the inner surface of the packaging article with an ultraviolet light (UV)-resistant coating.

109. The method of claim 101, further comprising: coating at least a portion of at least one of the inner surface or the outer surface of the packaging article with an antimicrobial and/or antiviral coating.

The particular embodiments disclosed above are illustrative only, as the disclosure may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is, therefore, evident that the particular embodiments disclosed above may be altered or modified and all such variations are considered within the scope and spirit of the disclosure. Accordingly, the protection sought herein is as set forth in the claims below.

What is claimed is:

1. A packaging article, comprising:
a wall having an outer surface configured to be visible to consumers and an inner surface configured to secure a product;
wherein the wall comprises one or more regions configured to be extracted from the wall, wherein all borders of the region or regions are identified on the inner surface and the region or regions are configured to form an article or articles other than the packaging article; and
wherein at least one of the following conditions is true:
at least one region is configured to be extracted from the wall by one or more actions selected from cutting along a perforation, untying a cord, cutting a cord, turning a screw, or two or more thereof to provide a cut out portion; and
the cut out portion may be folded to form a second article.

2. The packaging article of claim 1, wherein:
the wall comprises a plurality of regions, and the regions are configured to form more than one article other than the packaging article;
the wall has at least two zones, wherein at least one property of the wall differs between the zones, and at least a part of the borders of the region or regions is in a zone comprising less than half of the wall by volume;
at least one of the regions comprises a waterproof or water-resistant coating, wherein the waterproof or water-resistant coating is on the inner surface of the wall;
at least one of the regions comprises an ultraviolet light (UV)-resistant coating, wherein the UV-resistant coating is on the inner surface of the wall; or
the packaging article further comprises an antimicrobial and/or antiviral coating on at least a portion of at least one of the inner surface and the outer surface of the wall.

3. The packaging article of claim 1, wherein the second article is a planters box.

4. The packaging article of claim 1, wherein the cut out comprises a plurality of indicators for folding the cut out portion for forming the second article.

5. The packaging article of claim 1, further comprising:
one or more elements comprising text or graphics, wherein the element or elements are located on the outer surface and indicate the presence of the region or regions in the wall.

6. The packaging article of claim 1, further comprising:
one or more interior packaging bodies configured to cooperate with the inner surface to secure the product.

7. The packaging article of claim 6, wherein the interior packaging body or bodies are further configured to assist the region or regions in forming the article or articles other than the packaging article.

8. The packaging article of claim 1, wherein the region or regions is/are configured to be extracted from the wall by one or more actions selected from cutting along a line, separating along a score, tearing a perforation, withdrawal of a tab from a slot, removing a staple, separating two surfaces adhered to one another, untying a cord, cutting a cord, turning a screw, or two or more thereof.

9. The packaging article of claim 1, wherein the wall comprises a plurality of regions, and the regions are configured to form more than one article other than the packaging article.

10. The packaging article of claim 1, wherein the wall comprises a plurality of regions, and the regions are configured to form the article or articles by one or more actions selected from gluing, insertion of a tab into a slot, mating of two slots, stapling, tacking, riveting tying a cord, turning a screw, or two or more thereof.

11. The packaging article of claim 1, wherein the article or articles other than the packaging article are selected from pet feeders, pet beds, pet toys, pet houses, jewelry boxes, drawer dividers, tables, chairs, shelving units, mobile phone holders, tablet computer holders, laptop computer holders, media holders, organizers, storage units, toys, clothing and apparel folding aids, or two or more thereof.

12. The packaging article of claim 1, wherein the article or articles other than the packaging article are selected from dog feeders, cat feeders, bird feeders, small mammal feeders, reptile houses, or two or more thereof.

13. The packaging article of claim 1, wherein the article or articles other than the packaging article are selected from dog houses, cat houses, bird houses, small mammal houses, reptile houses, or two or more thereof.

14. The packaging article of claim 1, wherein the wall comprises paperboard, cardstock, cardboard, corrugated cardboard, plastic, metal, or two or more thereof.

15. The packaging article of claim 1, wherein the product is selected from mattresses, pillows, computers, televisions, audiovisual equipment, appliances, or furniture.

16. The packaging article of claim 1, wherein the wall comprises at least about 37.5% recycled material.

17. The packaging article of claim 1, wherein the wall has at least two zones, wherein at least one property of the wall differs between the zones, and at least a part of the borders of the region or regions is in a zone comprising less than half of the wall by volume.

18. The packaging article of claim 1, wherein at least one of the regions comprises a waterproof or water-resistant coating, wherein the waterproof or water-resistant coating is on the inner surface of the wall.

19. The packaging article of claim 1, wherein at least one of the regions comprises an ultraviolet light (UV)-resistant coating, wherein the UV-resistant coating is on the inner surface of the wall.

20. The packaging article of claim 1, wherein the packaging article further comprises an antimicrobial and/or antiviral coating on at least a portion of at least one of the inner surface and the outer surface.
